(19) United States
(12) Patent Application Publication
(10) Pub. No.: US 2008/0045275 A1
(43) Pub. Date: Feb. 21, 2008

(54) Mobile phone with dual power supplies

(75) Inventor: Jye-Ming Le, Taipei (TW)

Correspondence Address: BIRCH STEWART KOLASCH & BIRCH, PO BOX 747, FALLS CHURCH, VA, 22040-0747, US

(73) Assignee: COMPAL COMMUNICATIONS, INC.

(21) Appl. No.: 11/889,603

(22) Filed: Aug. 15, 2007

(30) Foreign Application Priority Data
Aug. 16, 2006 (TW) 095130123

(51) Int. Cl. H04M 1/00

(52) U.S. Cl. 455/572

(57) ABSTRACT

A mobile phone with dual power supplies includes a communication unit executing communication function and a multimedia unit executing multimedia function. The mobile phone further includes a first battery supplying power for the operation of the communication unit and a second battery supplying power for the operation of the multimedia unit. The communication unit and the multimedia unit use different batteries respectively, so as to avoid the situation that the communication function is unable to be used due to excessive use of the multimedia function.

### BACKGROUND OF THE INVENTION

1. Field of the Invention

The invention relates to a mobile phone and, more particularly, to a mobile phone, with dual power supplies, whose communication function and multimedia function use the separate power supply provided.

2. Description of the Prior Art

The functions of mobile phones nowadays are more and more complex. Besides the fundamental communication function, the multimedia functions, such as MP3 player, digital TV, game, 3D acceleration, and digital camera, etc. are also provided. As shown in FIG. 1, presently, the communication function and the multimedia function of the mobile phone 1 are mostly executed by a communication unit 11 and a multimedia unit 12 respectively, and both the communication unit 11 and the multimedia unit 12 share a single battery 13 for supplying their power. Many users often use the multimedia function of the mobile phone 1 for entertainment in their leisure time, such as when they are on the subway, on the bus, or in the bathroom.

However, the execution of the multimedia function is heavy on battery consumption and it will use up the limited power of the mobile phone 1, which results in less standby time of the mobile phone 1. Therefore, the user constantly feels that the mobile phone 1 is drained of power quickly, and such a problem sometimes makes the communication function unable to be used due to the excessive use of the multimedia function.

Therefore, to solve the problem of the shortened standby time, each manufacturer makes effort in decreasing the power consuming or increasing the battery capability without increasing the battery volume. However, these methods can not prevent the problem of disabled communication function resulted from excessive use of multimedia functions.

### SUMMARY OF THE INVENTION

Hence, the inventor of the present invention proposed using two batteries to supply power to the communication unit and the multimedia unit respectively to prevent the problem of disabled communication function resulted from excessive use of multimedia functions.

A scope of the invention is to provide a mobile phone with dual power supplies, which comes with a longer standby time for the communication function.

Thus, the mobile phone with dual power supplies of the invention comprises a communication unit, an input unit, a display, a multimedia unit, a first battery and a second battery independent of the first battery. The communication unit is in charge of the operation of the mobile phone and is used for executing a communication function. Through the input unit, the user inputs a control command to the communication unit. The display is controlled by the communication unit for displaying information. The multimedia unit is controlled by the communication unit for executing a multimedia function. The first battery supplies power to the communication unit, and the second battery supplies power to the multimedia unit.

### BRIEF DESCRIPTION OF THE APPENDED DRAWINGS

FIG. 1 is a schematic diagram illustrating a mobile phone of the prior art.

FIG. 2 is a schematic diagram illustrating a mobile phone with dual power supplies according to the first preferred embodiment of the invention.

FIG. 3 is a schematic diagram illustrating a mobile phone with dual power supplies according to the second preferred embodiment of the invention.

FIG. 4 is a control flow chart of the power supply according to the second preferred embodiment of the invention.

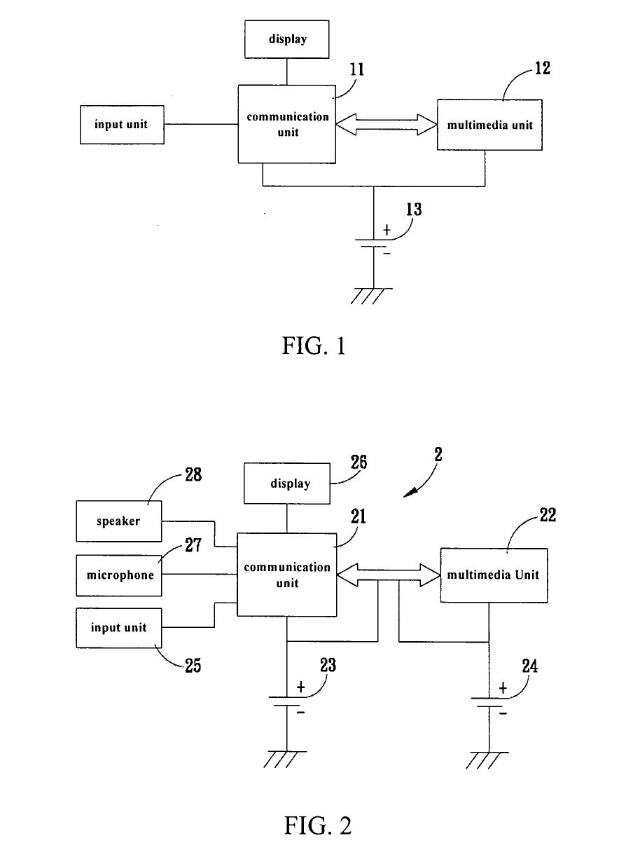

### DETAILED DESCRIPTION OF THE INVENTION

The above-mentioned and other contents, features, and effects, will be presented clearly in the following detailed descriptions of two preferred embodiments with the figures.

Before the detailed descriptions of the invention, it should be noted that in the following content that similar elements are presented by the same numbers.

Please refer to FIG. 2. The mobile phone 2 with dual power supplies according to the first preferred embodiment of the invention comprises a communication unit 21 in charge of the operation of the mobile phone 2, a multimedia unit 22, a first battery 23, and a second battery 24. Certainly, the mobile phone 2 in the embodiment further comprises fundamental members of the mobile phone 2, such as an input unit 25, for example, a keyboard for the user to input a control command, a display 26 controlled by the communication unit 21 for displaying information, a microphone 27 for transforming voices into electric signals, which are then transmitted to the communication unit 21, a speaker 28 controlled by the communication unit 21 for broadcasting voice, and the like. The members disclosed in the embodiment should not be limited by the description.

The communication unit 21 is in charge of receiving and sending radio signals for executing the communication function and works according to the control command inputted from the input unit 25. The multimedia unit 22 executes a multimedia function such as MP3 or image display function. The communication unit 21 can use a chip provided by manufacturers such as Texas Instruments (TI), Mediatek (MTK), Infineon, and the like, and the communication unit 21 can use a chip provided by manufacturers such as Samsung, Sunplus, and the like. The functions and the related operations of the communication unit 21 and multimedia unit 22 are well known to those skilled in the art and not the emphasis of the invention, so the related descriptions are omitted here.

The first battery 23 electrically connected to the communication unit 21 is used to supply power needed for the operation of the communication unit 21. The second battery 24 electrically connected to the multimedia unit 22 is used to supply power needed for the operation of the multimedia unit 22. To manage the power of the first battery 23 and the second battery 24, the communication unit 21 in the embodiment is equipped with a power managing function which can be integrated into the communication unit 21 via a programmed method. According to the power managing function, the communication unit 21 detects whether the power of the first battery 23 and the second battery 24 is lower than a threshold. When the communication unit 21 detects that the power of the second battery 24 is lower than the threshold, it sends a message to the display device 26, showing that the multimedia function is to be terminated, and reminds the user that the power from the second battery 24 is to be used up and then the multimedia unit 22 is stopped from executing the multimedia function. Furthermore, when the communication unit 21 detects that the power of the first battery 23 is lower than the threshold, the communication unit 21 sends a message to the display device 26, showing that the communication function is to be terminated, and stops executing the communication function. At this moment, the mobile phone 2 is to be shut down.

Furthermore, developing smaller models of mobile phones is an inevitable trend, but the volume of a battery increases with higher battery capability. In order to avoid increasing the size of the battery, in the first preferred embodiment of the invention, the sum of the capability of the first battery 23 and the second battery 24 do not exceed the capability of the battery of a conventional mobile phone. In other words, the battery capability of the conventional mobile phone is separated into two parts for this embodiment. Therefore, the sum of the volume of the first battery 23 and the second battery 24 is approximately equal to the volume of the battery of the conventional mobile phone, and the capabilities of the first battery 23 and the second battery 24 are both smaller than the capability of the battery of the conventional use. The capabilities of the first battery 23 and the second battery 24 can be equal or unequal according to the design requirements.

For example, if the capability of the prior battery is 700 mAh, the sum of the capabilities of the first battery 23 and the second battery 24 is estimated to be 630 mAh after being separated. Under the condition that the prior single battery is separated into two batteries and the sum of the volume of the two batteries is not larger than the volume of the battery of the conventional use, the sum of the capabilities of the first battery 23 and the second battery 24 is smaller than the capability of the battery of the conventional use and the loss is estimated at 10%.

The power consumption during standby time of the mobile phone is 2 mA, the power consumption for executing the communication function is about 200 mA, and the power for executing the multimedia function is also about 200 mA. According to the statistics, under normal condition, a general user uses the communication function for about 30 minutes a day, and uses the multimedia function for 1.5 hours, and the standby time is approximately measured at 22 hours.

According to the above-mentioned description, under normal condition, the total power consumption in one day is 200×0.5+200×1.5+2×22=440 (mAh), and then the battery of the prior art can be used for about 38.2 hours.

In the embodiment, the battery of the conventional use is supposed to be separated into two equal batteries, and the capabilities of the First battery 23 and the second battery 24 are both 315 mAh. The power consumption of the first battery 23 for the communication unit 21 in one day is 200×0.5+2×23.5=147 (mAh), so the first battery 23 can be used for about 51.4 hours. The second battery 24, supplying power to the multimedia unit 22, can be used for about 1.5 hours (the power consumption of the multimedia unit 22 is about 200 mA). Therefore, the use time of the communication function in the embodiment is prolonged for about 14 hours than that in the prior art, so as to prolong the standby time effectively and to remove the power problem of the voided communication function due to excessive use of the multimedia function.

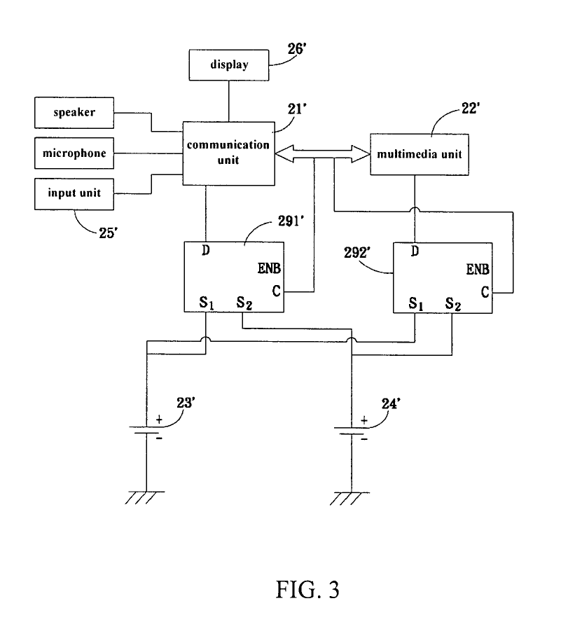

Furthermore, for the adaptability for power supplying, a mobile phone 2′ with dual power supplies according to the second preferred embodiment in the invention further comprises two multiplexers 291′ and 292′, as shown in FIG. 3. The multiplexer 291′ (indicated the second switch) comprises two input ends S1 and S2, which are connected to the first battery 23′ and the second battery 24′, an output end D connected to the communication unit 21′ and a control end C connected to the communication unit 21′. Another multiplexer 292′ (indicated the first switch) comprises two input ends S1 and S2, which are connected to the first battery 23′ and the second battery 24′, an output end D connected with the multimedia unit 22′ and a control end C connected with the communication unit 21′. The power management in this embodiment further comprises a mode setting function for the user inputting a mode setting command via the input unit 25′ to select one of the following terms consisted of a default mode in the above-mentioned embodiment and a custom mode. In the custom mode, the second battery 24′ supports the first battery 23′ when the power of the first battery 23′ runs low, and effectively prolongs the use time of the communication function. Generally, when the power remained in the first battery 23′ and the second battery 24′ are both enough, the communication unit 21′ control the multiplexers 291′ and 292′ to enable the first battery 23′ to supply power to the communication unit 21′ and the second battery 24′ to supply power to the multimedia unit 22′.

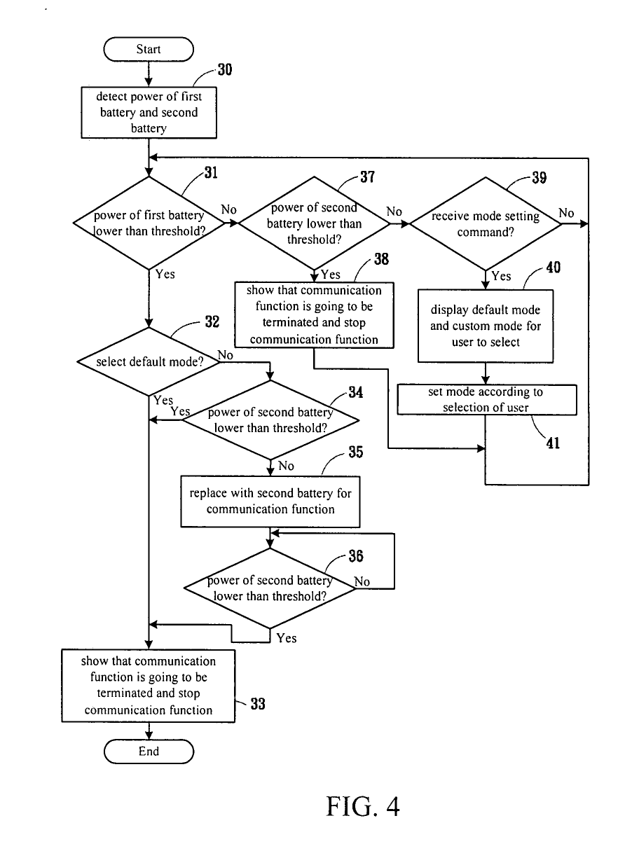

In this way, as shown in FIG. 4, after the mobile phone 2′ is switched on, the communication unit 21′ keeps detecting the power of the first battery 23′ and the second battery 24′ in step 30, so as to judge whether the power in the first battery 23′ is lower than a threshold in step 31. If yes, the communication unit 21′ judges whether the default mode is selected in step 32, and if no, it goes to step 37.

If it is judged that the default mode is selected in step 32, step 33 is executed and the communication unit 21′ sends the user a message, showing that the communication function is to be terminated via the display 26′, and then stops the communication function.

If it is judged that the default mode is not selected (i.e., the custom mode is selected) in step 32, the communication unit 21′ executes step 34 to judge whether the power remained in the second battery 24′ is lower than a threshold. If no, the communication unit 21′ controls the multiplexer 291′ to replace the first battery 23′ with the second battery 24′ for supplying power to the communication unit 21′ in step 35. And then the communication unit 21′ keeps detecting whether the power of the second battery 24′ is lower than the threshold in step 36, and if yes, the communication unit 21′ executes step 33 to stop the communication function.

However, if the judgment result is yes in step 34, the communication unit 21′ also executes step 33 to stop the communication function. Whereby, if the second battery 24′ still has enough power in the custom mode, the power for the operation of the communication unit 21′ can be supported by the second battery 24′ for achieving the purpose of longer communication time.

In step 37, the communication unit 21′ judges whether the power of the second battery 24′ is lower than the threshold. If yes, step 38 is executed and the communication unit 21′ sends the user a message showing that the multimedia function is to be terminated and then proceeds to stop the multimedia function. After step 38 finishes, it then goes to step 31. If the judgment result is no in step 37, it goes to step 39 to judge whether the mode setting command is received. If yes, the communication unit 21′ controls the display 26′ to display a default mode and a custom mode for the user to select in step 40 and then sets a mode in step 41 according to the selection of the user. After finishing step 41, and if the judgment result is no in step 39, it goes right back to step 31. It should be noted that the executing sequence of step 31, 37 and 39 can be adjusted according to the design requirements, and the steps are not limited to this embodiment.

According to the above-mentioned description, the mobile phones 2 and 2′ with dual power supplies of the invention use two sets of dual batteries 23, 23′, 24, and 24′ to supply power to the communication units 21, 21′ and multimedia units 22, 22′ respectively under the condition of not increasing the space occupied by the batteries. Whereby, the communication function and the multimedia function can use different power supplies without affecting one another. So that the use time of the communication units would not be influenced by the excessive use of the multimedia function, and the communication time can be prolonged.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A mobile phone, comprising:
a communication unit being in charge of the operation of the mobile phone and being used for executing a communication function;
an input unit, by which a user inputting a control command to the communication unit;
a display, controlled by the communication unit, for displaying information;
a multimedia unit, controlled by the communication unit, for executing a multimedia function;
a first battery for supplying power to the communication unit; and
a second battery being independent of the first battery for supplying power to the multimedia unit.

2. The mobile phone of claim 1, wherein the communication unit further detects whether the power of the second battery is lower than a threshold or not, and when the power of the second battery is lower than the threshold, the communication unit stops the multimedia unit from executing the multimedia function.

3. The mobile phone of claim 2, wherein when the power of the second battery is lower than the threshold, the communication unit sends the user a message showing that the multimedia function is going to be terminated.

4. The mobile phone of claim 3, wherein the communication unit controls the display to display the message showing that the multimedia function is going to be terminated.

5. The mobile phone of claim 1, further comprising a first switch controlled by the communication unit, one end of the first switch is selectively connected to the first battery or the second battery, and the other end of the first switch is connected to the communication unit, so as to enable the communication unit to receive the power supplied by the first battery or the second battery.

6. The mobile phone of claim 5, wherein when the user inputs a mode-setting command by the input unit, the communication unit controls the display to display a default mode and a custom mode for the user to select, and then sets a mode according to the selection of the user.

7. The mobile phone of claim 6, wherein the communication unit detects whether the power of the first battery is lower than a threshold or not, and when the power of the first battery is lower than the threshold and the default mode has been selected, the communication unit sends the user a message showing that the communication function is going to be terminated and then stops the communication function.

8. The mobile phone of claim 7, wherein when the power of the first battery is lower than the threshold and the custom mode has been selected, the communication unit duly controls the first switch to enable the communication unit to receive the power supplied by the second battery.

9. The mobile phone of claim 8, wherein when the power of the second battery is higher than or equal to the threshold, the communication unit controls the first switch to enable the communication unit to receive the power supplied by the second battery.

10. The mobile phone of claim 5, wherein the first switch is a multiplexer.

11. The mobile phone of claim 5, further comprising a second switch controlled by the communication unit, one end of the second switch is selectively connected to the first battery or the second battery, and the other end of the second switch is connected to the multimedia unit, so as to enable the multimedia unit to receive the power supplied by the first battery or the second battery.

12. The mobile phone of claim 11, wherein the second switch is a multiplexer.
